(19) United States
(12) Patent Application Publication
(10) Pub. No.: US 2010/0053458 A1
(43) Pub. Date: Mar. 4, 2010

(54) Method and System for Network Enabled Remote Controls Using Physical Motion Detection Remote control Devices

(75) Inventors: Howard Neil Anglin, Austin, TX (US); Kandagatia Chaitanya, Round Rock, TX (US); Emily Jane Ratliff, Austin, TX (US); Elizabeth Silvia, Austin, TX (US); Yvonne Marie Young, Bastrop, TX (US)

Correspondence Address: IBM CORPORATION;C/O DARCELL WALKER, ATTORNEY AT LAW, P. O. Box 25048, HOUSTON, TX, 77265, US

(73) Assignee: International Business Machines Corporation, Armonk, NY (US)

(21) Appl. No.: 12/433,235

(22) Filed: Apr. 30, 2009

Related U.S. Application Data
(63) Continuation of application No. 12/199,300, filed on Aug. 27, 2008.

(51) Int. Cl. H04N 5/50; H04N 5/44

(52) U.S. Cl. 348/731; 348/734; 348/E05.097; 348/E05.096

(57) ABSTRACT

A network enabled remote control system uses controls that detect the physical movements of the remote control devices. The system comprises a primary remote control device and one or more secondary remote control devices. The secondary remote control devices have motion-sensing capabilities that can transmit the detection of a motion of the controller to a sensing device. The motion-sensing device can have the capability to receive the transmitted detected motion and convert that detected motion into an executable command. The primary remote device can function as the sensing device.

### CROSS-REFERENCE TO RELATED APPLICATIONS

This application is related to and claims priority from U.S. patent application Ser. No. 12/199,300 filed on Aug. 27, 2008, the contents of which are incorporated herein by reference.

### FIELD OF THE INVENTION

This invention relates to a method and system for remote-to-remote communications and in particular to a method and system for motion detection communications between remote control devices for granting or denying access of a remote control device to desired content, and for communicating between a remote device and a tuner device via an intermediary remote device.

### BACKGROUND OF THE INVENTION

The wireless devices are becoming an increasing part of our society. Cellular telephones, television remote control devices, the computer mouse and video game remote controllers are example of wireless products that are in common use by people every day. Although wireless remote devices are common, these wireless devices do not all operate that same. Some of these devices are motion-sensing devices that can sense a movement of the device and convert that sensed movement into a command. The wireless muse and some video game controllers can sense movement of the device by a user and produce responses based on this sensed movement.

Many of these motion-sensing devices contain an accelerometer that facilitates in the detection of the motion. An accelerometer is an instrument that measures acceleration. Because it is difficult to measure acceleration directly, the device measures the force exerted by restraints placed on a reference mass to hold its position fixed in an accelerating body. The output is usually either a varying electrical voltage or displacement of a moving pointer over a fixed scale. Specially designed accelerometers are used in varied applications: control of industrial vibration test equipment, detection of earthquakes (seismographs), and input to navigational and inertial guidance systems. The Wii Remote by Nintendo is an example of a wireless remote that uses an accelerometer is its' operations.

However, still, a typical remote control device transmits an infrared beam to a receiver device. With regards to television viewing, the device receiving the infrared transmission is a tuner box incorporated in or located in close proximity to a tuner device that controls the channel selection of a television. This beam containing tuning information is received at tuner and adjustments in the form of channel selection are made based on this received information. This type of data transmission is a point-to-point transmission. As a result of this type of transmission, and the stationary nature of the tuner, these data transmission must occur in the general proximity of the tuner device. In addition, the remote device must be oriented and pointed at the receiver device such that straight-line point-to-point connection and data transmission can occur.

Some efforts are currently underway to enhance the capabilities of a remote control device with regard to selecting and viewing television programs. Acoustic Research claims a remote with built-in WiFi capabilities. The built in WI-Fi technology allows the user to use their connection to get the latest weather, reports, sports scores, headlines and what's playing on their favorite channels right to the color LCD display on the remote control. An Electronic Program Guide is automatically updated through the remote's wireless Wi-Fi connection, enabling the family to continue watching TV while searching the on-remote screen for optional cable, satellite or analog or digital broadcast programming choices. With individual customization capabilities, the viewer can select “All Channels”, “My Channels,” “My Shows” or sort the guide to display HDTV movies, family or sports programming. Another convenience option is the ability to view program details and set “reminders” for select program times. The viewer is provided with updates through the Wi-Fi connection of national headline news, sports, weather information and program guide listings based on a user's postal ZIP codes.

There are offerings on the market such as the miniLCD 2-way RF Handheld Remote by Creston®, with the intended ability to control multiple devices and in addition offers bi-directional communication between the remote and devices. Some known art offers a user the ability to connect directly to a service provider via a remote with the option of direct content delivery. However, there are no provisions for remote-remote content sharing or access control.

In addition, the television watching audience still relies of the point-to-point operations of the conventional remote control device. Typically, people customize or control broadcast/cable/satellite/etc programming and viewer preferences by changing settings on a set-top box (tuner box) or equivalent built in TV module. Additionally with the set-top boxes as mentioned, there is only one point of entry or control, preventing multiple users from simultaneously modifying profiles or preferences.

There is a need for a method and system that can decentralize the programming activities such that the user is not required to be in the general proximity of the set top box. In addition, there is a need for a remote control device that can operate to provide basic television watching functions such as channel selection and volume control without the need for point-to-point remote controller operations.

### SUMMARY OF THE INVENTION

Embodiments of the present invention describe a method and system that provides motion detection communications and conventional remote control communications between multiple remote control devices. These communications facilitate the sharing of data between the remote control devices and a system through which users control access to information.

The system of this invention comprises a primary remote control device and one or more secondary remote control devices. The secondary remote control devices have motion-sensing capabilities that can transmit the detection of an motion of the controller and transmit that detected motion to a sensing device. The motion-sensing device can have the capability to receive the transmitted detected motion and convert that detected motion into an executable command. The primary remote device can function as the sensing device.

In one embodiment, the sensing device can have an index of detectable motions and commands associate with that detected motion. The command determined from the detected motion would be processed and performed. A detected motion could be for changing a tuner upward. When the sensing receives and processes this motion, the tuner channel would be increase to a higher channel on the tuner.

As with the prior application Ser. No. 12/199,300, the primary remote control device can communicate directly with a set top tuner device to control programming between the tuner and the multiple remote control device system, regardless of the physical location of each remote control device. The primary remote controller has the capability to store information about each secondary remote in the system. The primary remote can communicate with the tuner and secondary remotes through local area or wide area networks. This system of the present invention decentralizes control of an actual broadcast or recorded program away from a set-top tuner box, to a portable decentralized electronic device such as a specialized remote control device. With this system, a user could retrieve programming information without the need to be in close proximity to the tuner box. In one embodiment of this system, the primary remote controller may incorporate some of the functionality of a set-top tuner box that would not be incorporated into the secondary remote controllers. In this system each user has his/her own remote controller that may be used to access information permitted for that particular user. To prevent a user from accessing another user's remote controller along with private data or personal profile, strict access control can be implemented, such as but not limited to biometrics.

Embodiments of the present invention also disclose a method to manage and control TV viewing habits from a portable device, namely the primary remote controller. A user having a secondary remote device could interact with this enhanced primary remote via signal transmissions using a touch screen display. The remote assumes that a network exists where remote controllers may communicate with each other as well as with a service provider. Each profile in a group consisting of a primary remote and secondary remotes is stored in the primary remote or is otherwise accessible to the primary remote over a wireless network. A distinct user in this system has a unique profile associated with the remote that the user will operate. In an embodiment, whenever there is an access attempt by the secondary remote, the primary remote or other device storing the profile of this secondary remote, detects this access attempt via a wireless network. At this point, a determination is made as to whether the user making the access attempt is permitted to tune to the attempted channel. If the access attempt is to a permitted channel, the tuner receives the access request and tunes to the desired channel or retrieves programming information for that channel.

Another embodiment of the present invention provides for direct communication and information exchange between remotes, both primary and secondary. In this method the user of the secondary remote can initiate changes to its user profile or request access to channels or content that are otherwise restricted. The primary remote, or more accurately the authorized user of the primary remote, may grant or deny such a request by a user of a secondary remote in either an automated or manual fashion.

### DESCRIPTION OF THE DRAWINGS

FIG. 1 shows a remote control device containing an accelerometer that facilitates the detection of movement of the remote control device.

FIG. 2 shows various types of motions that a user could perform in order to send a command.

FIG. 3 is an index of detectable motions of the user controlling the remote control and corresponding commands that can be performed.

FIG. 4 shows a network configuration of the present invention having a primary remote, secondary remotes and a set top tuner.

FIG. 5 shows a network configuration of the present invention having a primary remote, secondary remotes and a set top tuner and another secondary remote from a different local area network communicating with the primary remote and/or the set top tuner of the different local area network.

FIGS. 6a and 6b show configurations for the storage of user profile information in the primary remote control device.

FIG. 7 shows the configuration of data for a channel request submitted by a secondary remote controller.

FIG. 8 is a flow diagram of an embodiment of the method of the present invention that evaluates an access attempt by a secondary remote to programming.

FIG. 9 is a flow diagram of an embodiment of the method of the present invention that evaluates an access attempt by a secondary remote from one local network to programming on a set top tuner device from a different local area network.

FIG. 10 is a flow diagram of an embodiment of the method of the present invention that evaluates communications between a primary remote and a secondary remote.

FIG. 11 is a flow diagram of an embodiment of the method of the present invention that tracks and records viewing information of various users using information from the primary and secondary remote controllers.

### DETAILED DESCRIPTION OF THE INVENTION

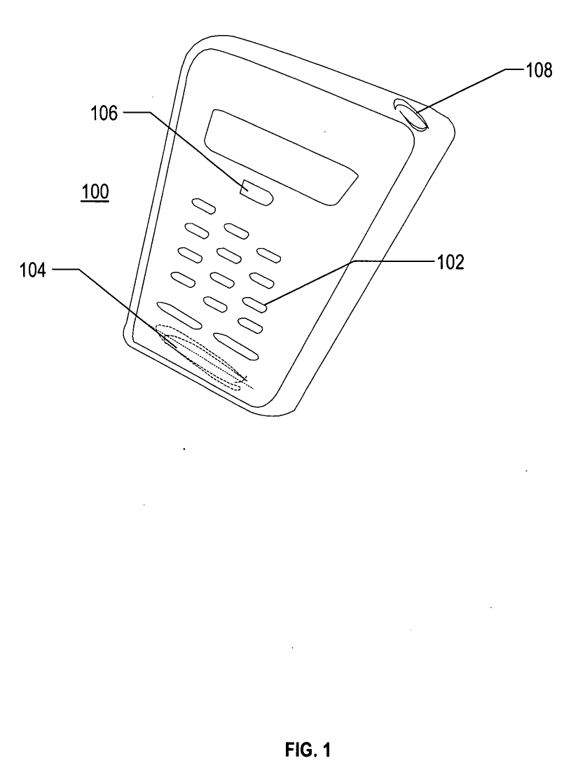

The system of the present invention comprises a sensor device and multiple remote control devices. The sensor device can be a primary remote control device as with the system on application Ser. No. 12/199,300. The critical device of the present invention is the wireless remote control device shown in FIG. 1. This remote 100 is similar to conventional remote control devices and can have buttons 102 for formulating and transmitting control information to a receiver such as a tuner or master remote control device. This remote can also have an infrared signal 108 to transmit information to the receiver. However, the remote of the present invention also has an accelerometer 104. With the present remote, in addition to having the capability to transmit infrared signals, there is the ability to transmit signals based on the information generated by the accelerometer 104. A separate button or trigger 106 could be incorporated into the remote that would be used to activate the accelerometer function of the remote.

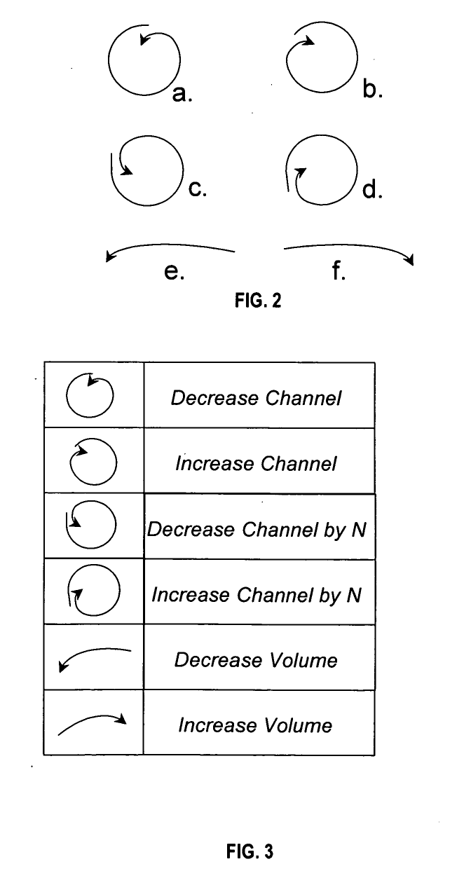

FIG. 2 shows examples of various types of motions that a user could perform with the remote control device in order to send a command to the receiver. These movements would be performed with the remote control device and could include the depression of the button 106 to activate the detection of the movements. As shown, movement ‘a’ is a counter clockwise movement that could be used in channel selection as illustrated in FIG. 3 to decrease the channel number of a tuner. Movement ‘b’ is a clockwise movement that be used in channel selection as illustrated in FIG. 3 to increase the channel number of a tuner. Movement ‘c’ is a forward-backward counter clockwise motion that could decrease the channel number by an ‘N’ number such as by 10 channels. For example, this type of movement could reduce the channel from channel 40 to channel 30 in one motion of the remote control device. Movement ‘d’ is a forward-backward clockwise motion that could increase the channel number by an ‘N’ number such as by 10 channels. This motion is similar to the motion of movement ‘c’. Movements ‘e’ and ‘f’ are simple directional movements of the remote control device. These movements could be for volume control.

As shown in FIG. 3, there can be a stored index of remote control motions and the corresponding commands for those motions. In operation, when a valid movement of the remote control device is detected, the accelerometer's measurement of that motion is sent to the receiver. The receiver identifies the motion and compares it to the motions in the index. When there is a match, the sensor or appropriate device performs the operation that corresponds to that detected motion. It is appropriate to note that not every movement of the remote control device results in a desired command for execution. Motions such as when the remote control device is dropped will not result in a valid executable command. In cases of invalid movements of the remote control device, the method will stop at the detection of an invalid command. This command validation can occur at the sensing device or even at the remote control device. For the invalidation to occur at the remote control device, the information in FIG. 3 would be stored in the remote control device. In addition, the use of button 106 can be an alternative embodiment to determine validity of remote movements. In embodiment, the only valid motions will be those that occur when the user depresses the button.

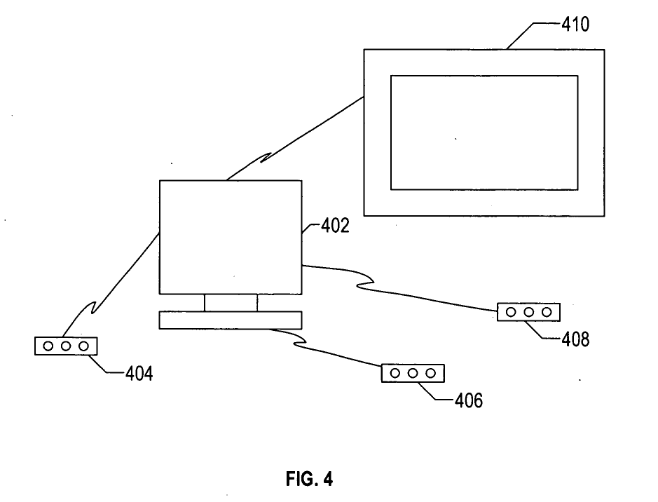

The present invention contains embodiments that describe a method and system for decentralizing tuning activities using multiple wireless remote control devices. FIG. 4 shows an embodiment of the system of the present invention comprising a primary remote controller 402, secondary remote controllers 404, 406 and 408 and a set top tuner 410. The primary controller can be equipped with the conventional capabilities of the remote controller and can also have some of the features of a set top tuner 410. These features could include the ability to restrict access to certain channels on the tuner by the secondary remote controllers. The primary remote controller also has storage capabilities for profiles of users using the remotes. The primary controller, secondary controllers and the set top tuner box will all have network access capabilities that will enable the devices to communicate with each via a wireless network. These network capabilities eliminate the need for the direct point-to-point communication currently implemented with infrared or other line of sight type of signals. The remotes can have a screen 312 that allows users to view programming information they are entitled to, without disturbing the content of a television program. This feature is especially useful when the person desiring the programming information is not in front of the set top tuner and display apparatus—television set—or if someone else is currently watching a television program.

A secondary remote controller 404 is equipped with the capabilities to access any channel available on the tuner 410. However, the actual channels to which a secondary controller will be permitted access are determined by the content of the user profile for that particular secondary remote that is stored in the primary remote. The secondary controller has the capability to communicate with the primary remote and the tuner box. This controller can request and retrieve information from the primary controller or the tuner box. Retrieved information is displayed on a screen contained on the secondary controller device.

The set top tuner device 410 contains all of the convention capabilities of a tuner. This device can be programmed to restrict access to certain channels identified by an authorized user. This tuner can also communicate via a local or wide network with a service provider or with an ad hoc collection of primary and secondary remote controllers. The tuner device 410 can contain verification software that may be enacted when a secondary remote controller attempts to interface with the tuner.

The remote control devices can have dual capabilities being able to detect and transmit motions and perform conventional remote transmissions. In this configuration, a secondary remote controller can communicate information to the primary remote or to another secondary remote. One application of this communication is exemplified when a user assigned a secondary remote controller submits a request to the primary remote controller to modify the access restrictions currently on that particular primary remote controller. Because of the networking communication capabilities, the primary and secondary remotes can exchange information over the communication network. In addition, other types of communication exchanges can occur such as requesting information from the primary remote controller and another secondary controller with regard to a particular program.

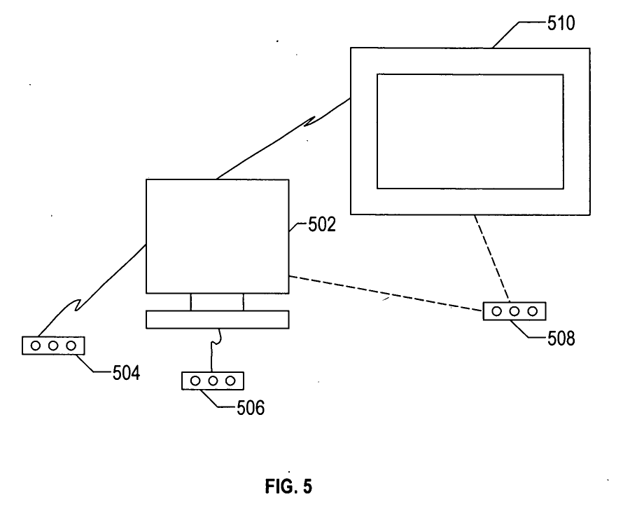

FIG. 5 shows a network configuration of the present invention having a primary remote, secondary remotes and a set top tuner and another secondary remote from a different local area network communicating with the primary remote and/or the set top tuner of the different local area network. This configuration of the present invention requires that both network configurations for the first and second sets of remote controller devices have the same service providers. When all remote controllers regardless of household or local network have the same service provider, it is possible for a secondary remote controller 504, 506, and 508 from another location to attempt to access programming at a different location. If this type of access attempt occurs, the primary remote controller 502 for the second network can still detect the access attempt and determine whether that particular remote controller 502 can access a desired channel. In a situation when the primary remote for that local network does not detect the access attempt, the tuner 510 for the second local network can detect the access attempt and determine whether to allow or deny the access attempt.

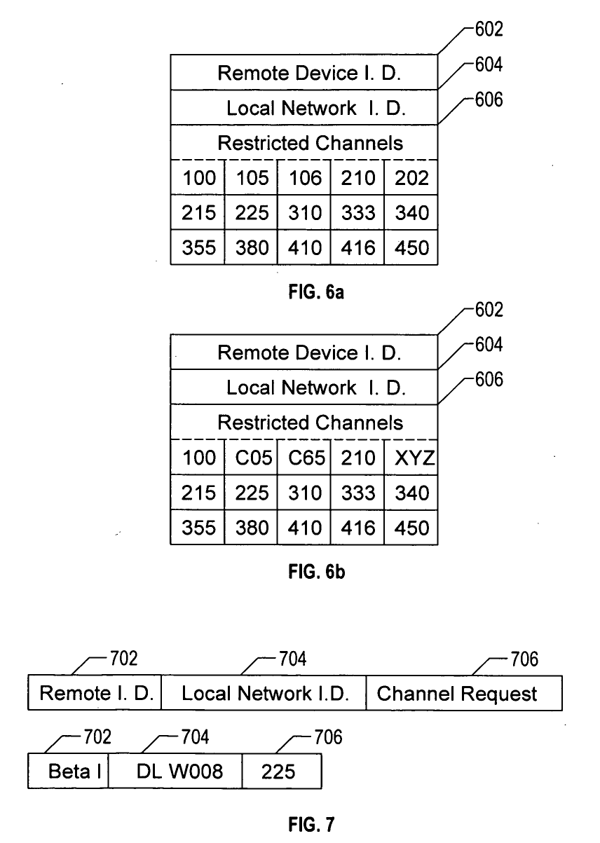

A primary application of the wireless remote devices having the capability to detect and transmit motions is in the implementation of the system described in U.S. patent application Ser. No. 12/199,300. As mentioned, there is a user profile for each person that will use one of the secondary remotes. Each secondary remote controller will require a user profile. FIGS. 6a and 6b show configurations for the storage of user profile information in the primary remote control device. In a user profile, shown is a field 602 that identifies the specific secondary remote controller device. A second field 604 identifies a specific local network for that remote. The local network could be the household of a particular subscriber. This approach is similar to some satellite companies that have the ability to track the number of receivers assigned to one subscriber. The identities could be assigned by a service provider or could be originated by the subscriber. When originated by the subscriber, the remote controller identities could be transmitted to the primary remote controller and to the tuner device and even to the service provider. The other information stored in the user profile is the set of restricted channels. These channels can indicate the channels to which the user of the particular secondary remote has access. However, the conventional approach is that this list of channels is the restricted channel list to which the user does not have access. The ability to restrict channel access based on individual secondary remote controllers is in stark contrast to the generally accepted approach of programming the tuner box to block certain channels. In the conventional application, the blocked channels are blocked for all users, not particular users. With this invention, it is possible to implement individual user viewing restrictions. In this profile, the fields 606 contain the channels to which the user does not have access. Once these restricted channels are programmed into the primary remote, if the user of the secondary remote with targeted profile attempts to access one of the restricted channels in that profile, the tuner will not respond to that access attempt. FIG. 6b shows a user profile in which a block of consecutive channels can be designated. In this example, channels 50 through 65 are all designated as restricted channels. In addition, if letters ‘XYZ’ designates a channel, the present invention can use the call letters and determine the corresponding channel for those letters. In this example, if the corresponding channel number for ‘XYZ’ is 200, the present invention will identify the channel number.

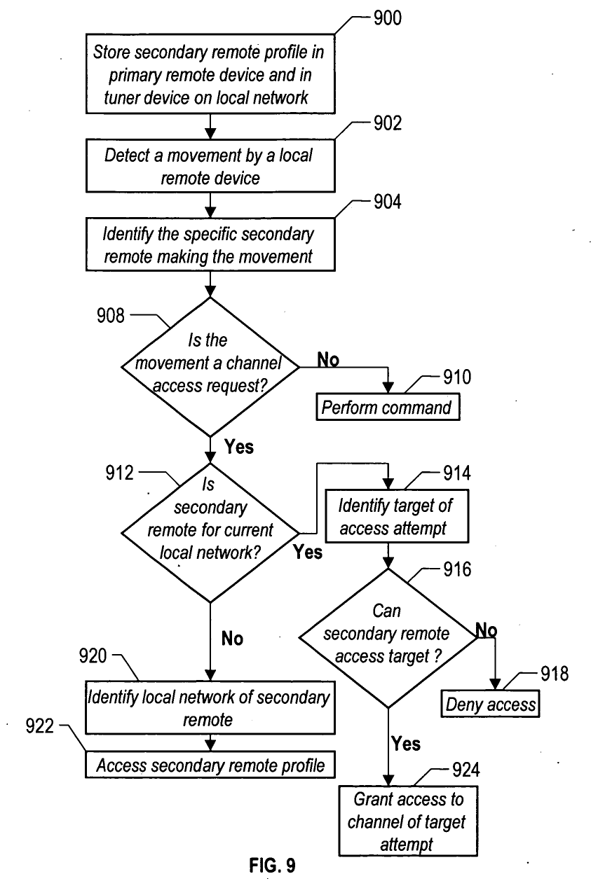

FIG. 7 shows a record containing data for a channel request made by a secondary remote controller. The information contained in a transmitted request includes the identification of the remote controller, the local network of the remote controller and the desired or requested channel. The record in FIG. 7a indicates fields 702, 704 and 706 for this information. In the embodiments of the present invention, each remote controller both primary and secondary can have a unique identification. In FIG. 7b, the remote identification field 702 is designated with the identity “Beta I”. The local network field contains the designation “DLW008”. These two fields 702 and 704 can be preset with these identities stored in the service provider server. When information is transmitted from a remote controller, the recipient of the transmission can identify the remote and network. As will be shown in FIG. 9, the information with regard to the network identity will be useful in determining the status of a channel request.

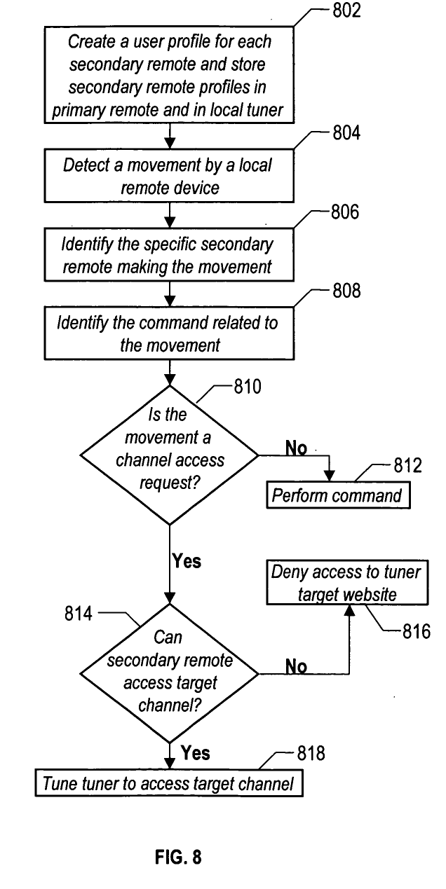

FIG. 8 is a flow diagram of an embodiment of the method of the present invention that evaluates an access attempt by a secondary remote to programming. In this method, there is a configuration of the local network in which there will usually be a set top receiver device, a primary and multiple secondary remote control devices. This local network is mainly a typical single-family household. In the initial step, 802, there is a creation of a user profile for each secondary device. The profile for a secondary remote controller will comprise the specific identification of the secondary remote controller 502 and a list of restricted channels or a list of accessible channels for that remote control device. The restriction may mean that the set of channels programmed in for a specific remote, can be channels that said remote is allowed to access. In the alternative, the restriction could also be the set of channels that the particular remote controller is prohibited from accessing. In this same step 802, the created profiles for each secondary remote are stored in the primary remote and optionally in the local tuner device 510. Alternatively the profiles for each remote can be replicated or stored on the service provider's servers, for later retrieval.

Step 804 detects movement by the remote control device. This motion detection device will not detect any movement of the device. In this application, only movements that correspond to the movements in the index will actually be considered valid movements. The remote control device will have the capability to detect any movement, but there can be capabilities within the actual remote control device to determine if the movement is a valid one contained in the index. When the determination is that the movement is a valid movement, this validity can be an indication of an attempt to access a channel via the local tuner. When the determination is that the detected movement is valid, step 806 identifies the specific secondary remote control device that is making the movement. This detected motion transmitted to the primary remote or sensing device. In this sensing device, step 808 identifies the actual command desired by the user. The identification is based on the movement index of FIG. 2b. Step 810 determines if the command is a channel selection request. It is possible for the command to be for volume adjustment or some other function other than selecting a channel from the tuner. Further, the method can be designed to only monitor channel selection activities. In that case, there would be no decision making function for the non-channel request commands. If, in step 810, the remote control movement is not for a channel request, the method moves to step 812, which performs the request.

Referring again to step 810, when the determination is that the detected motion is for a channel request, the method moves to step 814, which determines whether to grant access to the channel. Once the remote motion is converted into a command, the information in the channel access request command can be in the form of a record as discussed in FIG. 7. With the information contained in this record, this method can access the profile for that remote controller. From the information in the record, there is an identification of the target channel of the access request. From the remote controller identity, the remote profile and the target channel, step 814 determines whether that particular secondary remote is authorized to access that target channel. This access determination can be done by attempting to match the target channel with channels listed in the remote profile shown in FIG. 6. The channel matching will depend on what types of channels are in the profile. As mentioned, the profile can contain the allowed channels that a remote can access or the channels that the remote is prohibited from accessing. In one scenario, when the profile contains prohibited channels, if the target channel matches a channel in the profile the method moves to step 816 which denies the access attempt of the secondary remote controller. In a different scenario, when the allowed channels are in the profile, if the target channel does not match a channel in the profile, the method will deny the access attempt in step 814. With either scenario, if the determination is that access to the target channel is allowed, the method moves to step 818, which allows access. At this point, the primary remote can allow the transmission of the request to pass to the tuner and the change in channel can occur at the tuner.

When multiple local networks have the same service provider, it is possible for remotes from different local networks or households to communicate with each other. FIG. 9 describes the process that evaluates an access attempt by a secondary remote from one local network to programming on a set top tuner device from a different local area network. This method helps ensure that users of secondary remote controllers cannot circumvent restrictions for that specific remote controller by accessing programming information through a different local network.

In this method, step 900 stores a user profile for a secondary remote controller for that local network. As with the other embodiments, this profile contains channels to which the user can access or channels for which the user has prohibited access. If the user traveled to a different household having the same programming service, that user could possibly gain access to any programming provided by that service. The user can use the motion detection commands to submit a command to the sensing device of the different system. When the user of the remote from the first network makes a motion with the remote device, step 902 detects the movement and transmission of the remote device. This detection and transmission are received at the primary remote controller or sensing device of the second network or the tuner of the second network. Step 904 identifies the secondary remote from which the detected movement was transmitted. This identification step will occur at the device that detects the access attempt. The preferred approach is to have the primary remote for the second network detect and process the access attempt. If that device is not available, then the tuner for the second network can process the access attempt. With either device, next step 908 is to determine whether the movement is a channel access request. As with FIG. 8, when the request is not for a channel access, the method moves to step 910, which performs the request. If in step 908, the determination is that the movement is for a channel access request, the next step 912 is to determine whether that secondary remote is part of the local network. This determination can be accomplished by identifying the network identity that is contained in the access information. As previously mentioned, when a secondary remote transmits a request, the transmission contains the identity of the network of which the secondary remote is a part. When the determination is that the secondary remote is part of the local network where the request is made, the method moves to step 914 and proceeds to identify the target channel of the access attempt. The target channel is also contained in the information transmission of the access request. Once the requested channel has been identified, step 916 determines whether the user of the secondary remote has permission to access that requested channel. In this step, the user profile for that remote is searched in the same manner as in step 814. If the search attempt results in the requested channel not being permitted, then the method moves to step 918, which denies the access attempt. If the determination is that the secondary remote controller making the access attempt does have permission to access the requested channel, the method moves to step 918, which allows access to the channel.

Referring back to step 912, if the determination is that the secondary remote making the access request is not part of the particular local network where the request is made, step 920 identifies the local network of the remote making the request. Again, this identification is made from information contained in the network identity field 704 of the transmission request. Once the secondary remote making the request and its' local network has been identified, step 922 accesses the user profile for that remote. This user profile information can be stored in the server of the service provider. The method then moves to step 914 and proceeds to identify the target channel of the access attempt. Once the requested channel has been identified, step 916 determines whether the user of the secondary remote has permission to access that requested channel. In this step, the user profile for that remote is searched in the same manner as in step 816. If the search attempt results in the requested channel not being permitted, then the method moves to step 918, which denies the access attempt. If the determination is that the secondary remote controller making the access attempt does have permission to access the requested channel, the method moves to step 924, which allows access to the channel. This access can be allowed even when the secondary remote making the request is from a different local network. In other embodiments, there can prohibitions procedures in place to prevent such an access attempt when the attempt is from a remote controller that is not part of that local network.

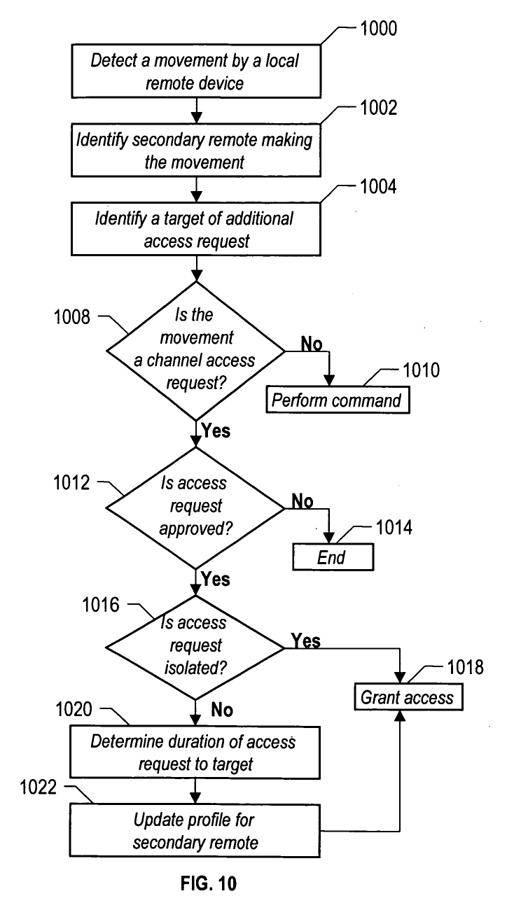

Another embodiment of the present invention enables the primary remote and secondary remotes in a local network to communicate with each other. These types of communications between remotes usually occur when a secondary remote requests a change to the user profile of the secondary remote. FIG. 10 illustrates a flow diagram of an embodiment of the method of the present invention that evaluates communications between a primary remote and a secondary remote. Step 1000 detects the movement of a secondary remote controller. This access attempt will be slightly different from a standard access attempt. In this access attempt, the user desires not only to access a channel, but the have the profile for that user changed such that the desired channel will be accessible. This access attempt by the secondary remote goes to the primary remote to seek approval to access a channel. In the regular access attempt process, the access attempt is submitted with the intent of immediately making a channel change and not getting approval from the primary remote. Step 1002 determines the identity of the secondary remote making the movement. From this information, the method in the primary remote can retrieve the user profile for that remote control device. Step 1004 identifies the target of the request and the access attempt request by the movement of the secondary remote. This information tells the primary remote that this access attempt is really a specific request to access a channel that is not currently accessible by the secondary remote user. Step 1008 determines whether the movement is for a channel request or other type of request. When the determination is that the movement is not for a channel request, step 1010 performs the requested command.

Referring to step 1008, when the determination is that the request is for a channel access, the method moves to step 1012 notifies the primary remote user of the access request. The notification will include the remote controller identity and the requested channel. In step 1012, the user of the primary remote controller can determine whether or not to allow the access request. When the user denies the access request, the method moves to step 1014, which denies the access request. At this point, the method terminates.

If in step 1012, the channel request is approved, the method moves to step 1016, which determines whether this access request is a one-time request or if it is a permanent request. In some situations, it may be desirable to grant temporary access to a secondary remote controller. In other situations, it may be desirable for the secondary user to have permanent access to a channel. For example, a new channel may become available from the service provider. This new channel may be acceptable to the primary remote control user. When the request is acceptable, step 1018 grants access to the channel. The secondary user making the request can now change the tuner to that channel for that secondary remote. To enact this change, the primary remote can make the change for the user of the secondary remote that made the request. Step 1020 determines whether the request is for a temporary change or a permanent change. The request could be for the purpose of watching a specific program on that channel one time. However, the request could also be to have access to that channel for an extended period of time. If channel request is more long term or permanent, it would be necessary to change the user profile for the user of that remote. Step 1022 updates the user profile to reflect a long-term change.

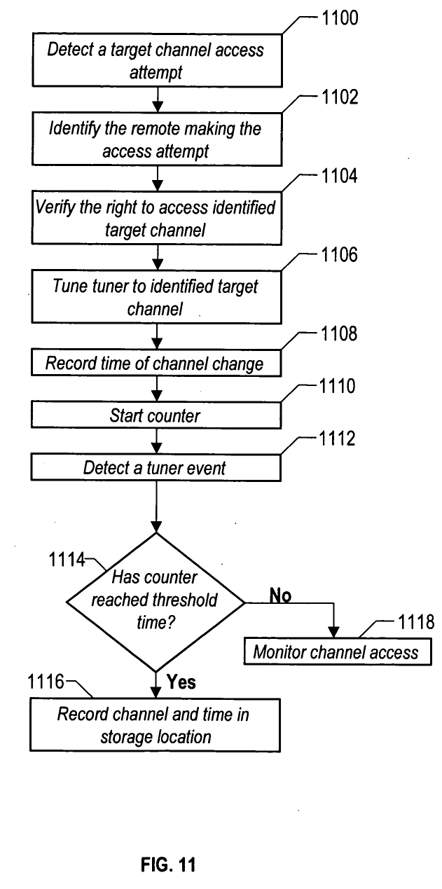

Another embodiment of the present invention shown in FIG. 11 illustrates a flow diagram of a method that tracks and records viewing information of various users using information from the primary and secondary remote controllers. This viewing information can be used to determine the viewership for various television programs. In this method, step 1100 detects a target access attempt at the primary controller. This step is similar to the detection of an access attempt in the other described embodiments of this invention. The access attempt can be either from the primary remote or from one of the secondary remotes. Step 1102 identifies the remote device that is making the access attempt. The target channel on the access attempt is then verified in step 1104. This verification process includes determining whether the remote making the access attempt has the right to access the target channel. As with the other embodiments of this invention, when the remote device does not have the right to access the target channel, access is denied and the process terminates.

Referring again to step 1104, when the determination is that the remote device does have the right to access the target channel, in step 1106, the tuner box tunes to the target channel. At this point, in step 1108, information related to the tuning of tuner box to the target channel is recorded. The recording can be either in the tuner box or in the primary remote. The initial recorded information is the start time that the tuner switched to the target channel. In one embodiment, the viewer will have to watch a television program for a minimum period of time for the information on that program to be recorded. This minimum period of time or threshold time could be set by the user or could match the parameters currently used to determine what percent of time one has to watch a program to meet the requirement for a watched program. To determine the time threshold, step 1110 starts a timer when the target channel is accessed. Step 1112 detects a program or tuner event. This event could be the end of a program, a change in channels at the tuner or turning off the tuner. When an event is detected, step 1114 makes a determination of whether the counter has reached the threshold time. If the elapsed time has reached the threshold time, step 1116 records the channel and time in a storage location. This information could be stored in the tuner box or transmitted to the service provider server. If the elapsed time has reached the threshold time, the timer information is discarded and the method returns to a monitor state in step 1118.

It is important to note that while the present invention has been described in the context of a fully functioning data processing and television programming system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape floppy disc, hard disk drive, RAM, and CD-ROMs.

We claim:

1. A method for selection of tuning control options from a remote control device capable of detecting remote control movements that correspond to tuning option selections comprising:
creating a remote control device profile for each secondary remote control device, the profile defining control limitations for each remote control device;
detecting a movement at a secondary remote control device;
determining whether the detected movement is for a command for a tuning option selection;
when the determination is that the movement is for a command for a tuning option selection, determining whether the movement is for a channel access request;
when the determination is that the movement is for a channel access request, determining whether the channel access request is a for a specifically identified channel;
when the determination is that the access attempt is for a specific channel, identifying the specific secondary remote control device making the access attempt;
identifying the program channel that is the target of the access attempt; and
determining whether the secondary remote control device making the access is allowed to access the program channel that is the target of the access attempt.

2. The method as described in claim 1 further comprising before said movement detection step, the step of creating an index of secondary remote control movements and tuner commands that correspond to each remote control movement.

3. The method as described in claim 1 wherein said determining whether the movement is for a channel access request step further comprises:
identifying the detected movement;
determining whether the detected movement is a valid movement by comparing the detected movement to tuner command movements in the created index; and
when there is match between the detected movement and a tuner command in the created index, identifying the matched tuner command.

4. The method as described in claim 3 wherein said determination that the movement is for a command for a tuning option selection further comprises performing the command when the determination is that the movement is not for a channel access command.

5. The method as described in claim 1 wherein said determining whether a programming channel is accessible by a particular secondary remote control device further comprises comparing the identified target program channel for which access is attempted with the channels in the profile of the secondary remote control device to determine whether the identified program channel is in the remote control profile and determining whether to grant access to the target channel to the particular secondary remote control device based on the comparisons of the target channel and the channels in the secondary remote controller profile.

6. The method as described in claim 5 further comprising after said creating a secondary remote controller profile for each secondary remote control device, storing a created secondary remote controller profile in the primary remote and in a tuner device.

7. The method as described in claim 6 wherein said detecting an attempt by a secondary remote control device to access a program channel through a local program tuner device further comprises determining whether a secondary remote control device making the access attempt is part of the same local network as the primary remote control device detecting the access attempt.

8. The method as described in claim 7 further comprising, when the determination is that the secondary remote control device making the access attempt and the primary remote control device detecting the access attempt are not on the same local network, identifying the local network of the secondary remote control device making the access attempt, accessing the profile of the secondary remote control device.

9. The method as described in claim 6 wherein said detecting an attempt by a secondary remote control device to access a program channel through a local program tuner device further comprises determining whether a secondary remote control device making the access attempt is part of the same local network as the primary remote control device detecting the access attempt.

10. The method as described in claim 6 wherein said detecting an attempt by a secondary remote control device to access a program channel through a local program tuner device further comprises determining whether a secondary remote control device making the access attempt is part of the same local network as the tuner device through which access is attempted.

11. The method as described in claim 1 wherein said detecting a movement at a secondary remote control device step further comprises detecting non-gravitational accelerations of a secondary remote control device.

12. A system for selection of tuning control options from a remote control device capable of detecting remote control movements that correspond to tuning option selections comprising:
a central tuner device capable of receiving information transmitted on a plurality of frequencies;
a programming service provider capable of transmitting programming over a plurality of frequencies;
a primary remote control device capable of communicating with the central tuner device and switching frequencies of the central tune device in order to select a frequency from which the tuner device will receive transmitted programming from the programming service provider;
one or more secondary remote control devices capable of communicating with the primary remote, said secondary remote control devices capable of detecting movements at said remote control devices; and
a software module for allowing the primary remote controller device to control access capabilities of the secondary remote control devices to programming through the central tuner.

13. The system as described in claim 12 wherein a said secondary remote control device further comprises an accelerometer capable detecting non-gravitational accelerations of the said secondary remote control device and an accelerometer activation button that activates the accelerometer when said accelerometer activation button is depressed by a user.

14. The system as described in claim 13 wherein a said secondary remote control device further comprises one or more buttons for selecting tuning options, said buttons capable of working in combination with said accelerometer to select tuning options.

15. The system as described in claim 14 further comprising software in said secondary remote control device that processes inputs from said one or more buttons and inputs from said accelerometer to determine a desired tuning selection.

16. The system as described in claim 12 wherein said software module further comprises a routine for creating a secondary remote controller profile for each secondary remote control device that is in a local network, the secondary remote control device profile comprising a record with various fields that contain information about the secondary remote control device, the information including a secondary remote control identification and a list of programming channels for which the secondary remote control device has restricted access.

17. A computer program product stored in a computer readable storage medium for selection of tuning control options from a remote control device capable of detecting remote control movements that correspond to tuning option selections comprising:
instructions creating a remote control device profile for each secondary remote control device, the profile defining control limitations for each remote control device;
instructions detecting a movement at a secondary remote control device;
instructions determining whether the detected movement is for a command for a tuning option selection;
when the determination is that the movement is for a command for a tuning option selection, instructions determining whether the movement is for a channel access request;
when the determination is that the movement is for a channel access request, instructions determining whether the channel access request is a for a specifically identified channel;
when the determination is that the access attempt is for a specific channel, instructions identifying the specific secondary remote control device making the access attempt;
instructions identifying the program channel that is the target of the access attempt; and
instructions determining whether the secondary remote control device making the access is allowed to access the program channel that is the target of the access attempt.

18. The computer program product as described in claim 17 further comprising before said movement detection instructions, instructions creating an index of secondary remote control movements and tuner commands that correspond to each remote control movement.

19. The computer program product as described in claim 17 wherein said instructions determining whether the movement is for a channel access request step further comprise:
instructions identifying the detected movement;
instructions determining whether the detected movement is a valid movement by comparing the detected movement to tuner command movements in the created index; and
when there is match between the detected movement and a tuner command in the created index, instructions identifying the matched tuner command.

20. The computer program product as described in claim 17 wherein said instructions determining whether a programming channel is accessible by a particular secondary remote control device further comprises instructions comparing the identified target program channel for which access is attempted with the channels in the profile of the secondary remote control device to determine whether the identified program channel is in the remote control profile and instructions determining whether to grant access to the target channel to the particular secondary remote control device based on the comparisons of the target channel and the channels in the secondary remote controller profile.
